(19) United States
(12) Patent Application Publication
(10) Pub. No.: US 2002/0035491 A1
(43) Pub. Date: Mar. 21, 2002

(54) System and associated methods for providing claimant services with increased quality assurance

(75) Inventor: Robert M. Dombroski, Sanford, FL (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: Access Transport Services, Inc., Altamonte Springs, FL (US)

(21) Appl. No.: 09/960,416

(22) Filed: Sep. 21, 2001

Related U.S. Application Data
(60) Provisional application No. 60/234,096, filed on Sep. 21, 2000.

(51) Int. Cl. G06F 17/60

(52) U.S. Cl. 705/4

(57) ABSTRACT

The system is for use in providing services to a claimant by a service vendor, as scheduled by a scheduler, and paid for by a payor, and includes a server for processing and storing claimant data and connected to the Internet, and at least one scheduler workstation for scheduling services for a claimant. The workstation includes a scheduler computer connected to the server, and a telephone interface connected to the PSTN. The server includes a quality assurance unit for generating requests to the scheduler computer before and after the scheduled service for contacting the claimant, and for generating requests to the scheduler computer before the scheduled service for contacting the service vendor.

### RELATED APPLICATIONS

This application is based upon and claims priority from copending provisional application Serial No. 60/234,096 filed Sep. 21, 2000, the disclosure of which is incorporated by reference herein in its entirety.

### COPYRIGHT NOTICE

A portion of the disclosure of this patent document contains material that is the subject of copyright protection. The copyright owner does not object to the reproduction of the patent disclosure as it appears in the public patent files of the United States Patent and Trademark Office, but otherwise reserves all other rights in the copyrighted material.

1. Field of the Invention

The present invention relates to computer networks, and more particularly, to the scheduling of services and retrieval of claimant records via a computer network.

2. Background of the Invention

Conventional methods of scheduling and dispatching services, such as transportation, for insurance claimants are time consumming, inefficient and unreliable for case managers and claims adjusters. For example, in the field of workers compensation insurance, case managers may be managing many claimants who, due to their injuries, cannot drive themselves to a doctor appointment or to physical therapy. In these cases, it is conventional for the case managers to arrange for the claimant to be transported to the appointment via a taxi, ambulance or independent transporter. It is critical that the claimants see their physician or physical therapist, for example, to ensure recovery and reduce the long term cost of their claim.

Scheduling transportation typically requires many phone calls between the case manager, the claimant, the physician and/or the service vendor, such as the ambulance company. Additionally, many appointments are missed because of poor communication or miscommunication between the the case manager, the claimant, the physician and/or the transportation provider. Such missed appointments increase the overall cost of the claimant's healthcare.

Some transportation providers allow insurance companies to request transportation for claimants via the telephone, facsimile or email. However, there is no real time confirmation or verification that the claimant was transported, attended the appointment and was transported home again. The case manager may only see a bill in a few weeks requesting payment for the requested transportation without any verification that the service was actually provided. In other words, the quality assurance of the conventional approaches is minimal.

### SUMMARY OF THE INVENTION

In view of the foregoing background, it is therefore an object of the invention to provide a system and method for use in providing services to a claimant by a service vendor, as scheduled by a scheduler, and paid for by a payor with increased quality assurance for the payor.

This and other objects, features and advantages in accordance with the present invention are provided by a system, operable over the public switched telephone network (PSTN) and Internet, for use in providing services to a claimant by a service vendor, as scheduled by a scheduler, and paid for by a payor, including a server for processing and storing claimant data and connected to the Internet, and at least one scheduler workstation for scheduling services for a claimant. The workstation includes a scheduler computer connected to the server for entry of claimant data by the scheduler and display of claimant data to the scheduler, and a telephone interface connected to the PSTN for communication between the scheduler and at least one of the payor, claimant and service vendor. The server includes a quality assurance unit for generating requests to the scheduler computer before and after the scheduled service for contacting the claimant, and for generating requests to the scheduler computer before the scheduled service for contacting the service vendor.

The services may include at least one of transportation and language translation, and the quality assurance unit may generates requests to the scheduler computer during the scheduled service to verify the service is being provided. Preferably, the services comprise at least one of transportation, translation, delivery of durable medical equipment (DME), and delivery of pharmaceuticals. The server may include a report generation unit for generating at least one of completed-service, late-service, canceled-service and missed-service reports on the server for the payor to access via the Internet. Such reports are downloadable by the payor into a spreadsheet document on the payor computer. The report generation unit may also generate at least one of a transport-type report, claimant transport report, claimant employer transport report, transportation savings report, list of claimants report, transport by county report, and ICD-9 transport report.

The server may include a payor secure online ordering unit for permitting the entry and review of claimant data via the Internet, and/or a billing unit for verifying service performed by the service vendor and for generating bills for the payor. The billing unit verifies mileage of transportation provided by the service vendor. The payor is preferably a workers compensation insurer and the claimant is a workers compensation claimant.

Objects, features and advantages in accordance with the present invention are also provided by a method, operable over the public switched telephone network (PSTN) and Internet, for use in providing services to a claimant by a service vendor, as scheduled by a scheduler, and paid for by a payor, including processing and storing claimant data on a server connected to the Internet, and scheduling services for a claimant via at least one scheduler workstation. Again, the workstation may include a scheduler computer connected to the server for entry of claimant data by the scheduler and display of claimant data to the scheduler, and a telephone interface connected to the PSTN for communication between the scheduler and at least one of the payor, claimant and service vendor. The method also includes generating requests to the scheduler computer before and after the scheduled service for contacting the claimant, and generating requests to the scheduler computer before the scheduled service for contacting the service vendor.

### BRIEF DESCRIPTION OF THE DRAWINGS

FIG. 1 is a schematic diagram of the system of the present invention.

FIG. 2 is a schematic diagram of the server of the system of FIG. 1.

FIGS. 3-16 are examples of user interfaces generated by the server of FIG. 2.

FIG. 17 is a flowchart illustrating the steps for registering a new claimant on the system of FIG. 1.

FIG. 18 is a flowchart illustrating the steps for scheduling service for a claimant on the system of FIG. 1.

FIG. 19 is a flowchart illustrating the relationship between the claimant data stored on the system of FIG. 1.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

As will be appreciated by those skilled in the art, portions of the present invention may be embodied as a method, data processing system, or computer program product. Accordingly, these portions present of the invention may take the form of an entirely hardware embodiment, an entirely software embodiment, or an embodiment combining software and hardware aspects. Furthermore, portions of the present invention may be a computer program product on a computer-usable storage medium having computer readable program code on the medium. Any suitable computer readable medium may be utilized including, but not limited to, static and dynamic storage devices, hard disks, optical storage devices, and magnetic storage devices.

The present invention is described below with reference to flowchart illustrations of methods, systems, and computer program products according to an embodiment of the invention. It will be understood that blocks of the illustrations, and combinations of blocks in the illustrations, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, implement the functions specified in the block or blocks.

These computer program instructions may also be stored in a computer-readable memory that can direct a computer or other programmable data processing apparatus to function in a particular manner, such that the instructions stored in the computer-readable memory result in an article of manufacture including instructions which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

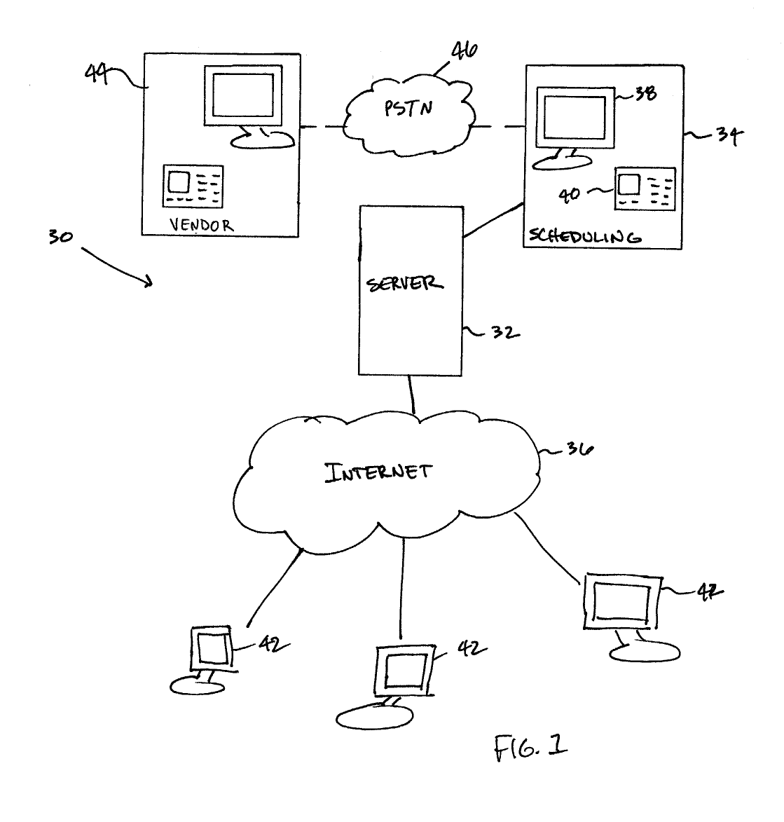

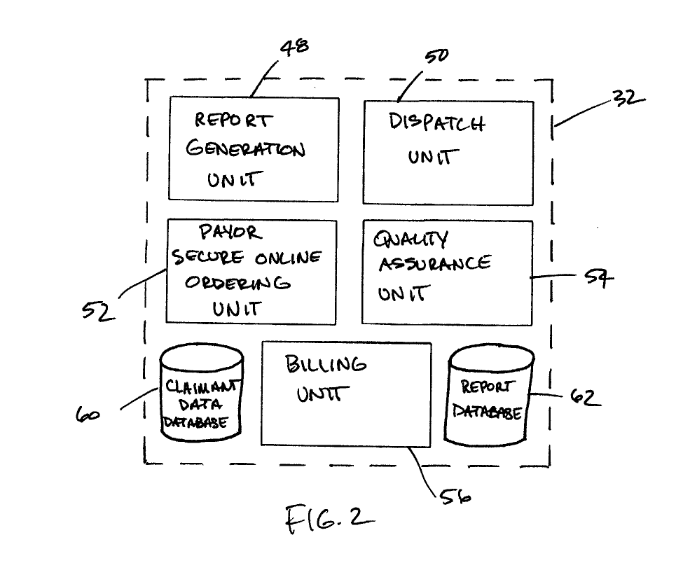

Referring to FIGS. 1 and 2, a system 30, operable over the public switched telephone network (PSTN) 46 and a computer network 36, for use in providing services to a claimant by a service vendor 44, as scheduled by a scheduler, and paid for by a payor, will now be described. The payor is preferably, for example, a workers compensation insurer and the claimant is, accordingly, a workers compensation claimant. As mentioned above, in the field of workers compensation insurance, case managers may be managing many claimants who, due to their injuries, cannot drive themselves to a doctor appointment or to physical therapy. In these cases, it is conventional for the case managers to arrange for the claimant to be transported to their various healthcare appointments. The service vendors typically comprise at least one of independent transportation providers, taxi companies and ambulatory companies. Also, the services may include language translation, delivery of durable medical equipment (DME), and delivery of pharmaceuticals.

The computer network 36 may be an intranet, local area network (LAN) or wide area network (WAN), for example. However, for the present invention, the computer network 36 is preferably the Internet. The system 30 may be implemented with an Application Service Provider (ASP) model utilizing the functionality of the Internet. The system 30 provides a comprehensive claimant services management and record keeping methodology which is accessible from a claim adjuster or case manager's office. Accordingly, there is no need to install on-site software and all that is necessary for an insurer to access the system 30 is a web browser and an Internet connection, as would be appreciated by the skilled artisan.

The system 30 includes a server 32 for processing and storing claimant data. The server 32 is connected to the Internet 36, and may include a plurality of dedicated servers, as well as various firewalls and databases as would be appreciated by those skilled in the art. At least one scheduler workstation 34 is connected to the server 32 for scheduling services, such as transportation, for a claimant. The workstation 34 includes a scheduler computer 38 connected to the server 32 for entry of claimant data by the scheduler and display of claimant data to the scheduler. The workstation also includes a telephone interface 40 connected to the PSTN 46 for communication between the scheduler and at least one of the payor, claimant and service vendor 44. For example, the case manager for the insurer, may call and order transportation or translation services while the scheduler enters the request into the system 30 via the scheduler computer 38. As will be described further below, the insurer may also order the services via the Internet 36. Of course, a plurality of workstations 34 may be provided for performing, individually or in combination, the above described functions. Also, other dedicated workstations 34 for performing related functions such as dispatching or billing may be provided as needed based upon the size and efficiency of a particular system.

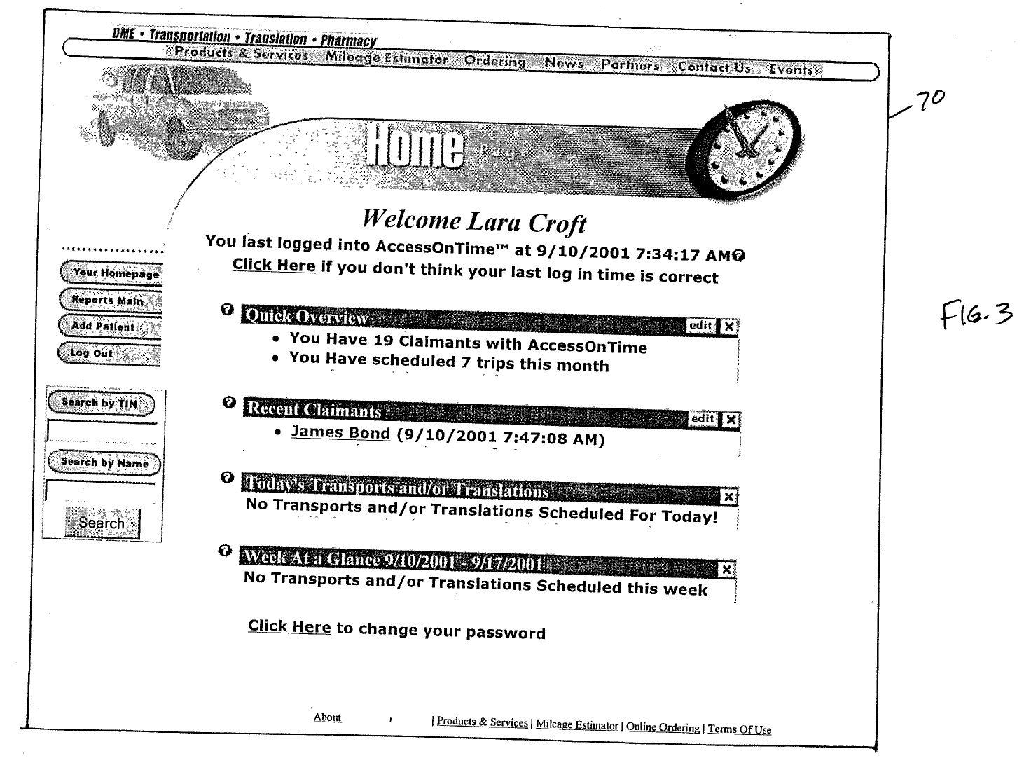

The system also includes at least one payor computer 42 for accessing claimant data on the server 32 via the Internet 36 by the payor. In the described example, an authorized case manager, claim adjuster or even a managed care nurse may access and review the claimant data on the server 32 to more efficiently manage a particular insurance claim and the associated claimant services. Such access may include the use of a customized homepage 70 (FIG. 3) for the insurer generated by the server 32.

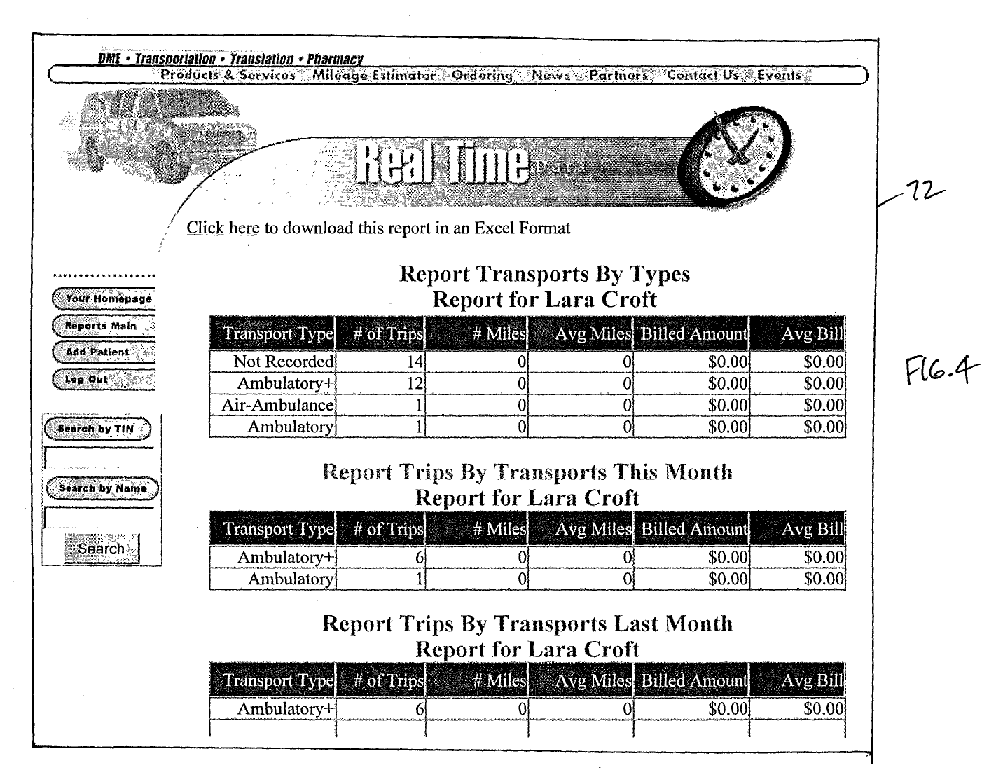

Referring now to FIG. 2, the server 32 may include a report generation unit 48 for generating reports based upon claimant data for the payor. The reports are preferably downloadable by the payor into a spreadsheet document on the payor computer 42, and when the service provided is transportation, for example, the reports may include transport-by-type reports, claimant transport reports, claimant employer transport reports, transportation savings reports, list of claimants reports, transport by county reports, and ICD-9 transport reports, which will be described in further detail below with reference to FIGS. 4-11.

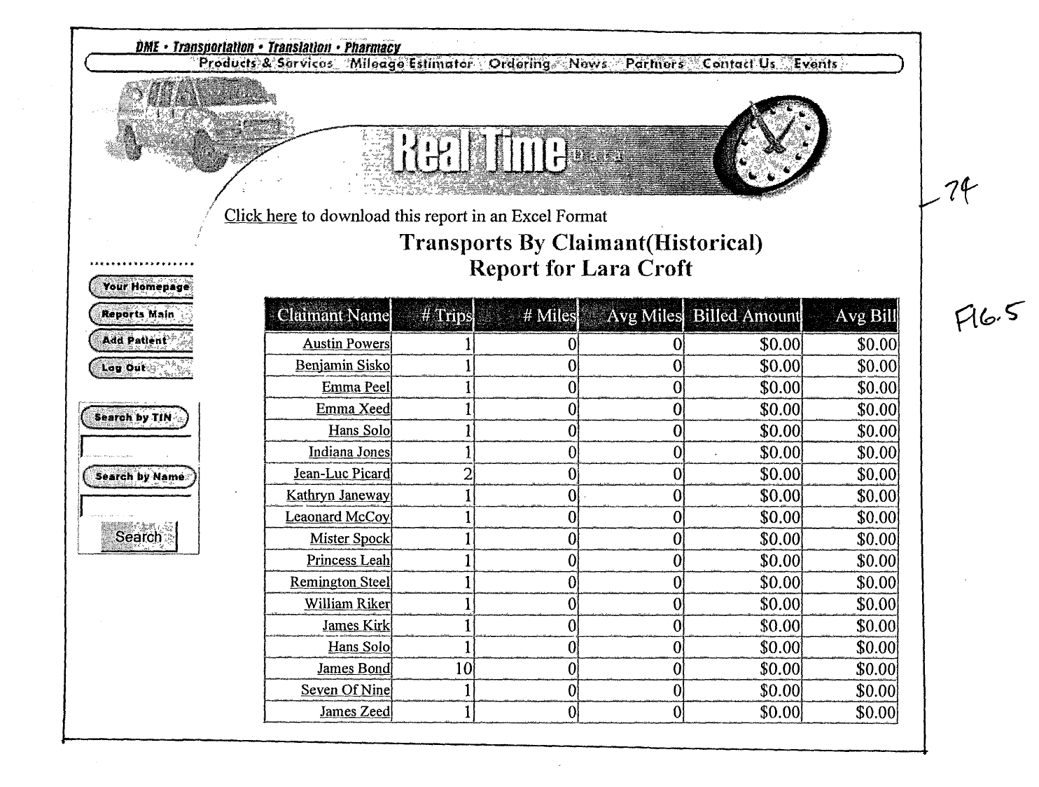

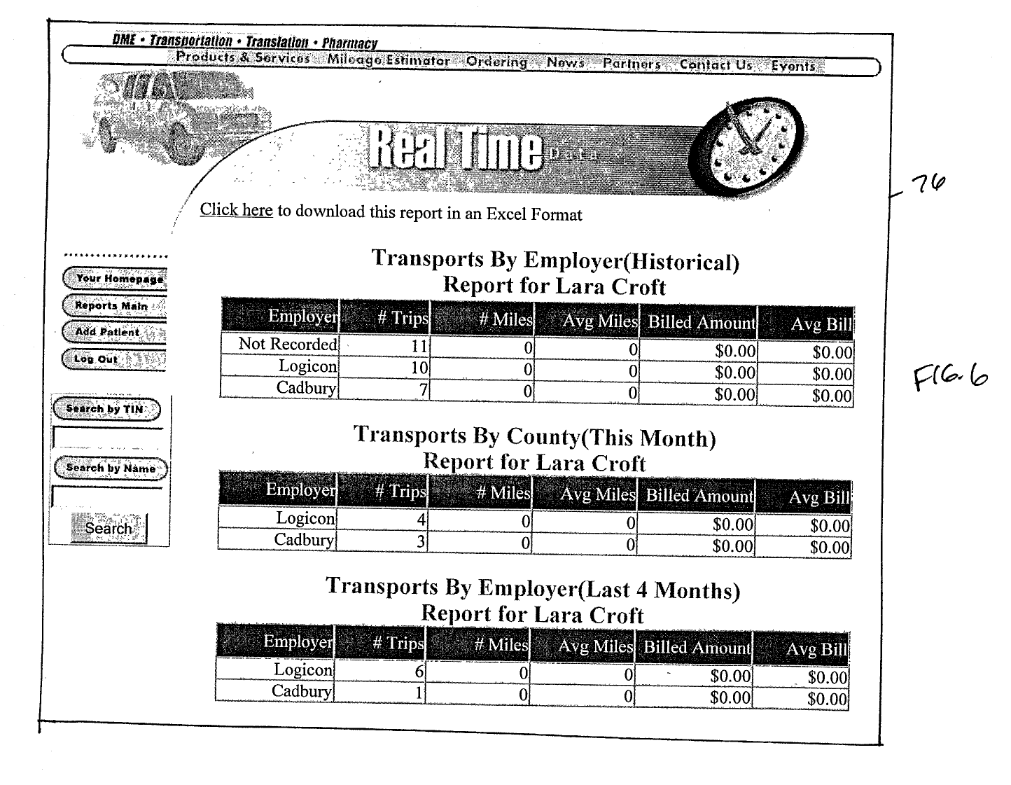

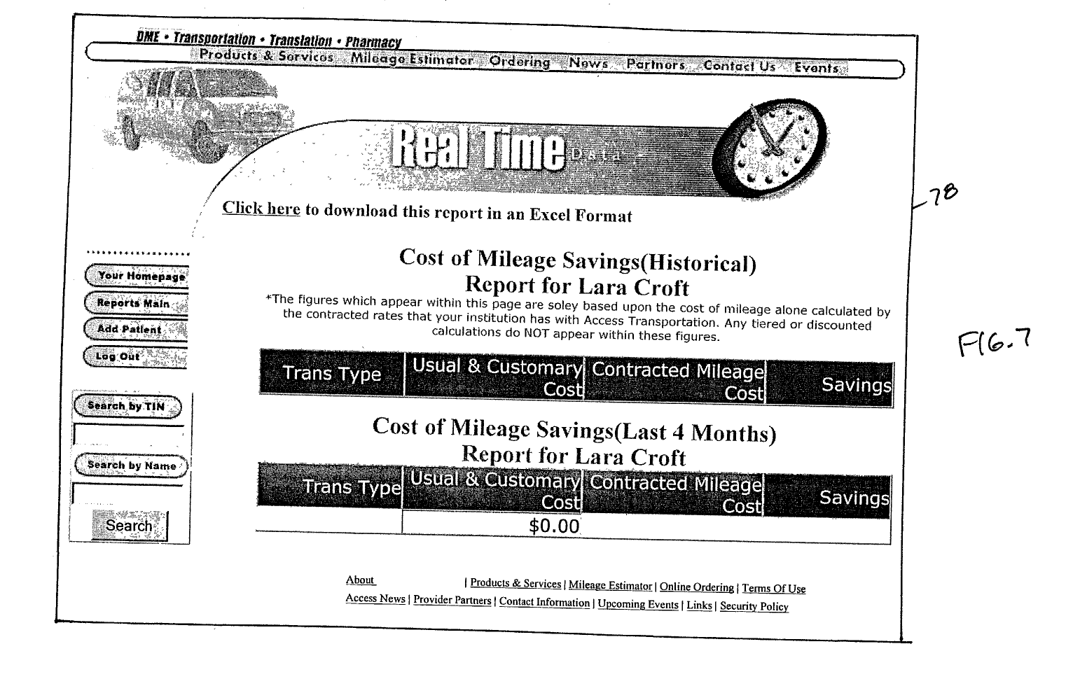

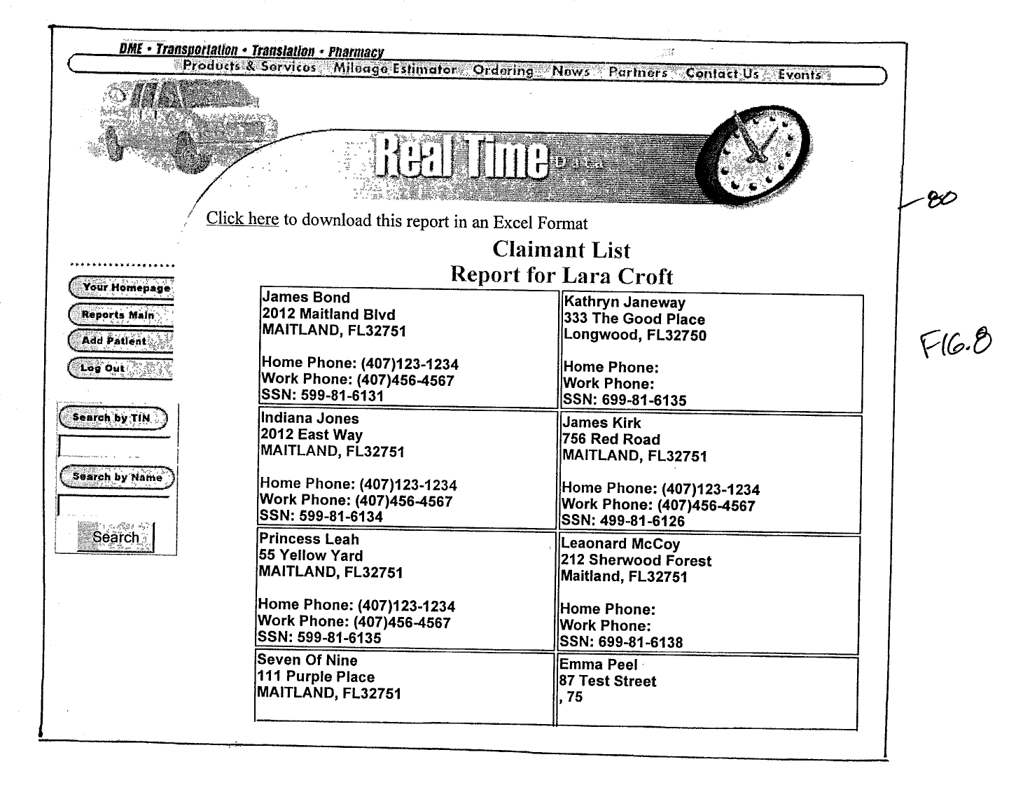

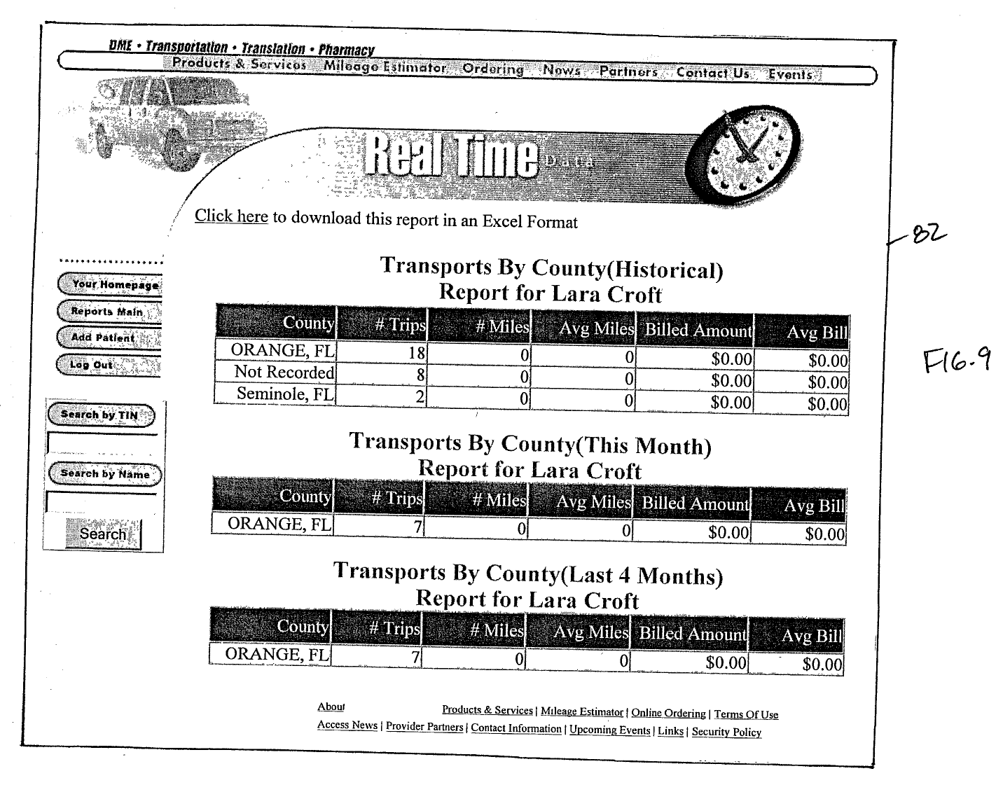

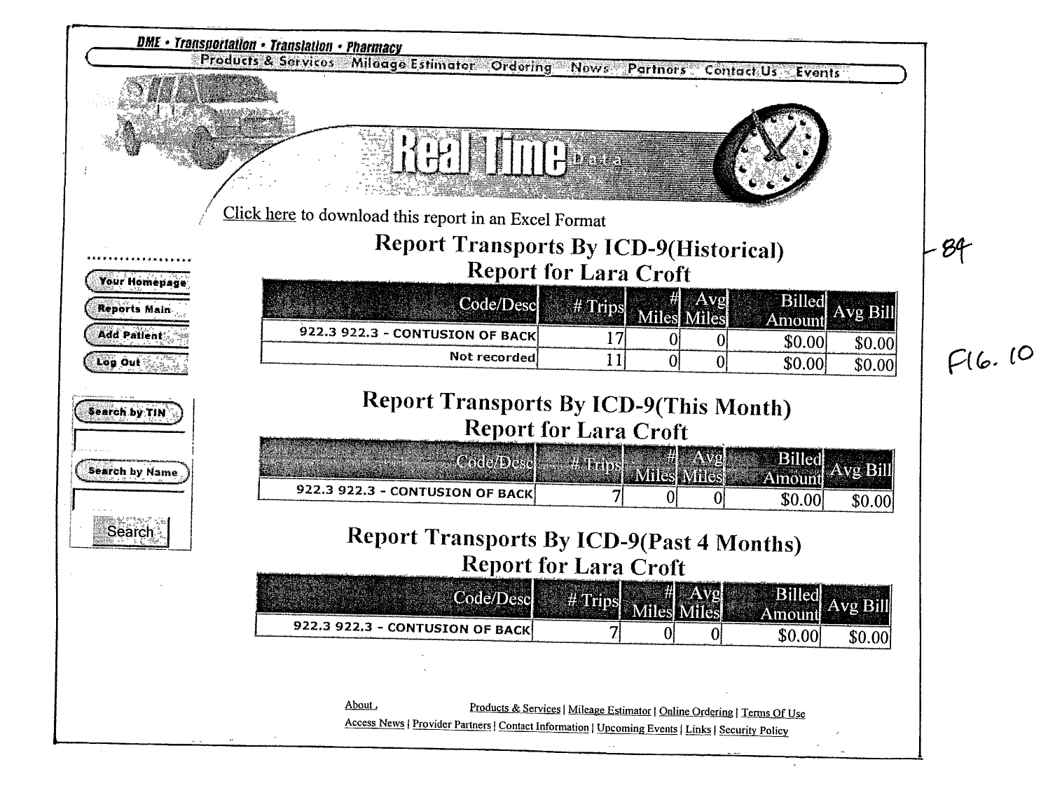

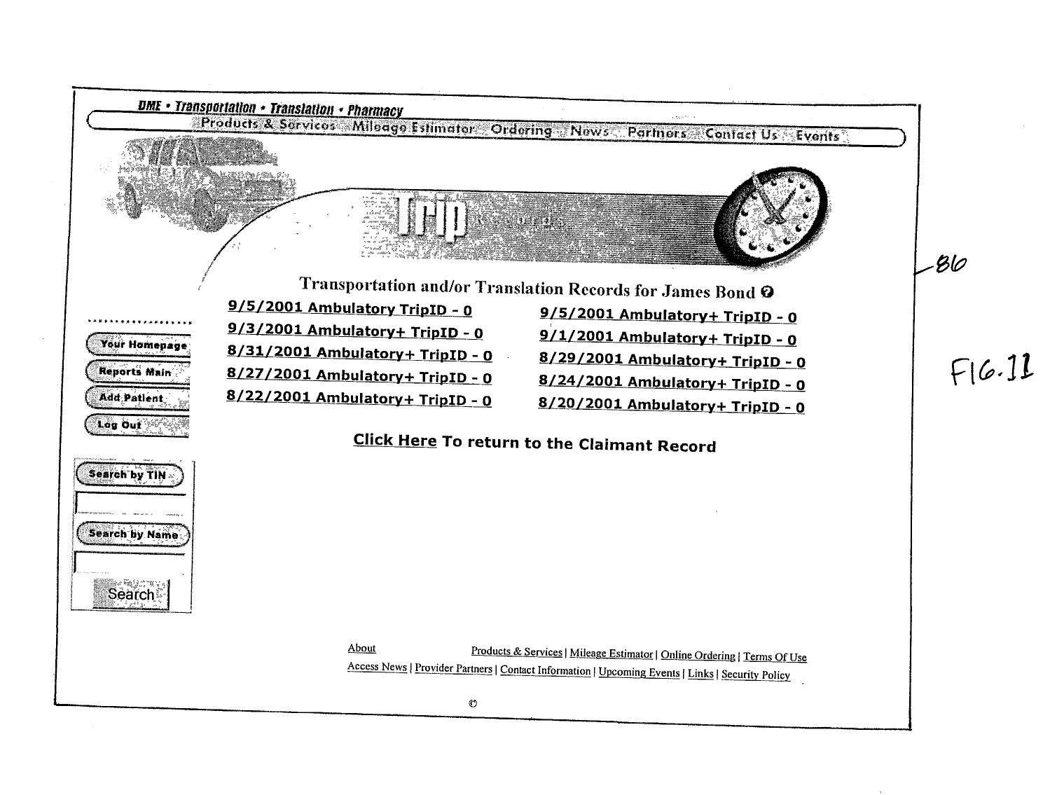

The transport-by-type report 72 (FIG. 4) summarizes claimant data for all claimants of the payor based upon transport mode, mileage, cost and average cost. The claimant transport report 86 (FIG. 11) summarizes claimant data for a single claimant based upon transports taken, cost and mileage. The claimant employer transport report 76 (FIG. 6) summarizes cost of services for an employer of at least one claimant. The transportation savings report 78 (FIG. 7) summarizes mileage cost savings for the payor. The list of claimants report 80 (FIG. 8) lists all claimant's names, identification numbers, addresses, phone numbers, and employment information for the payor. The transport by county report 82 (FIG. 9) summarizes the cost of providing services within each county that at least one claimant resides for the payor. The ICD-9 transport report 84 (FIG. 10) summarizes the cost of providing services based upon a diagnosis of claimants of the payor. Of course, other reports such as customized historical reports 74 and 86 (FIGS. 5 and 11), for example, may also be generated.

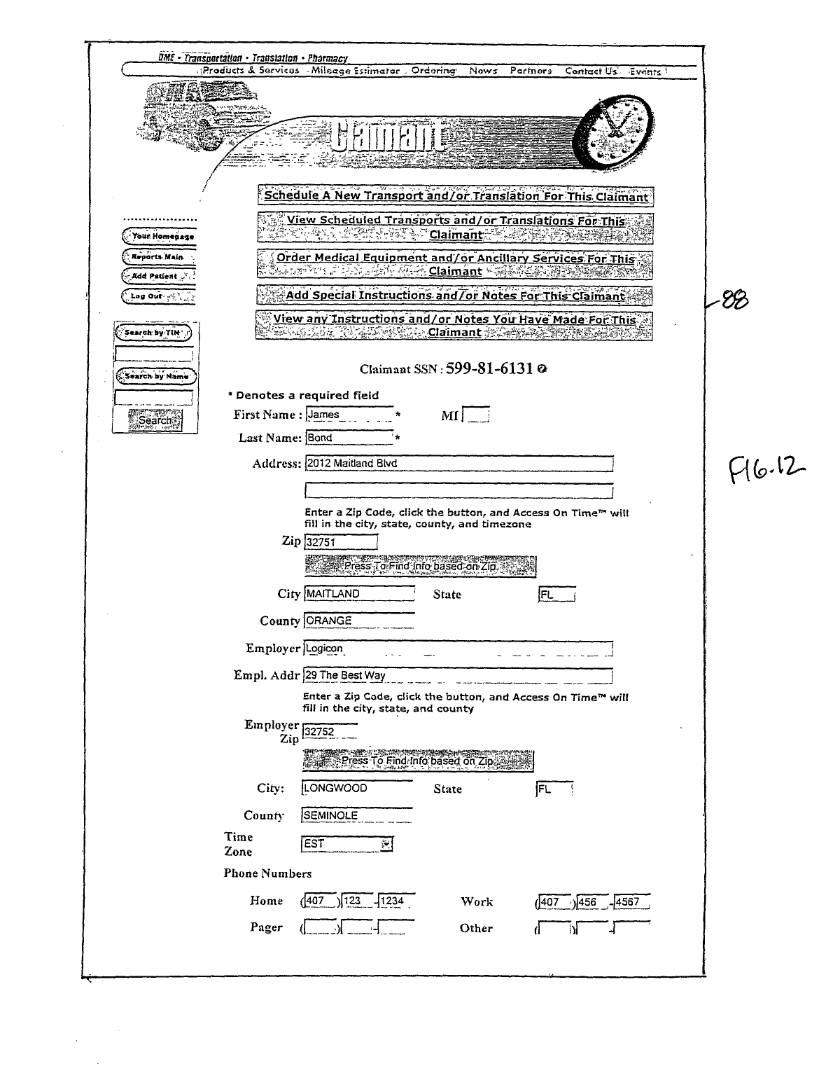

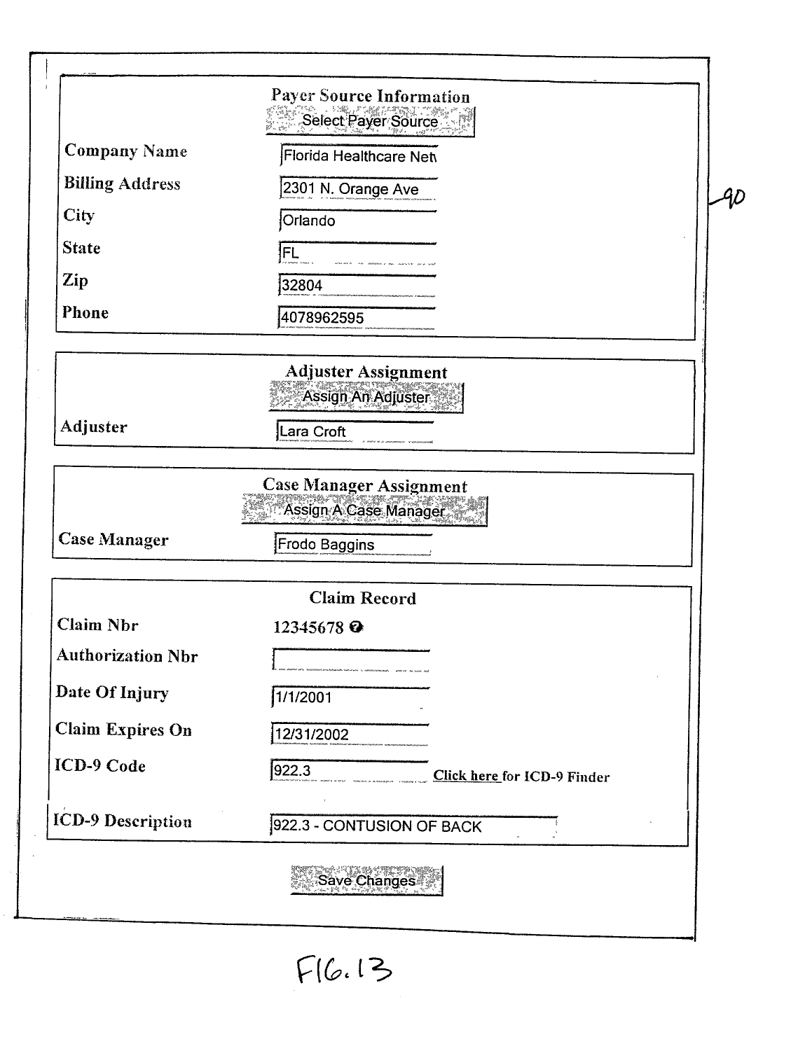

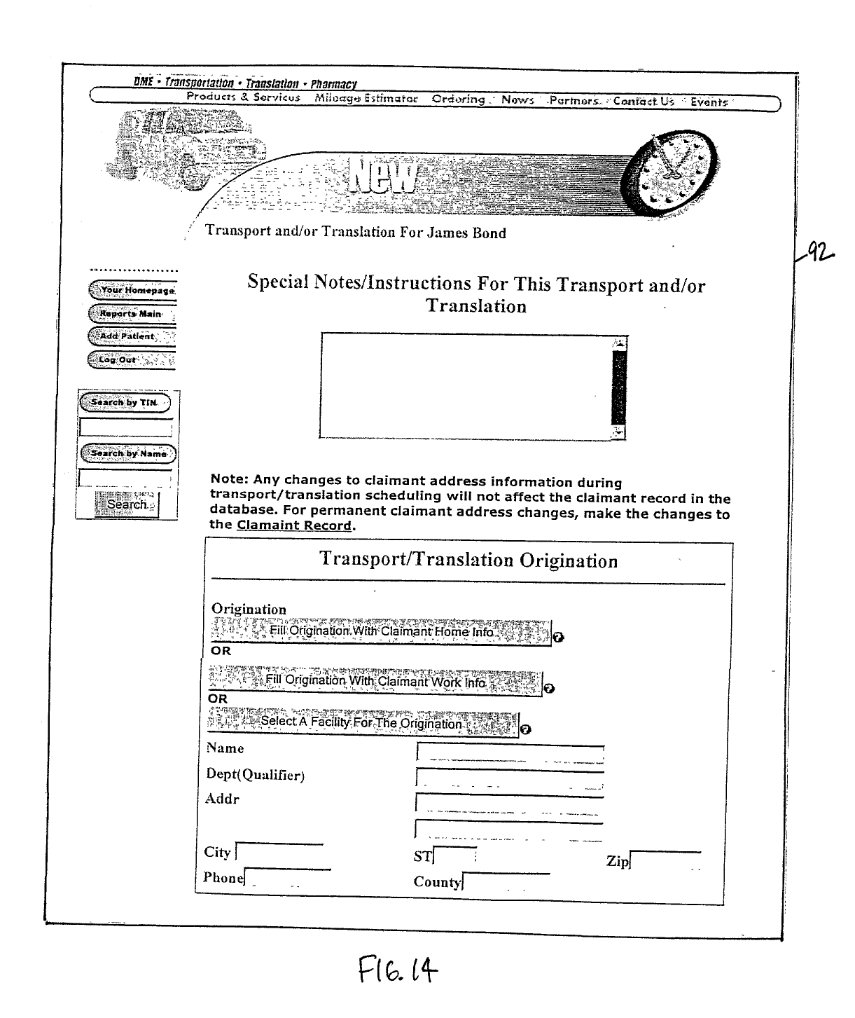

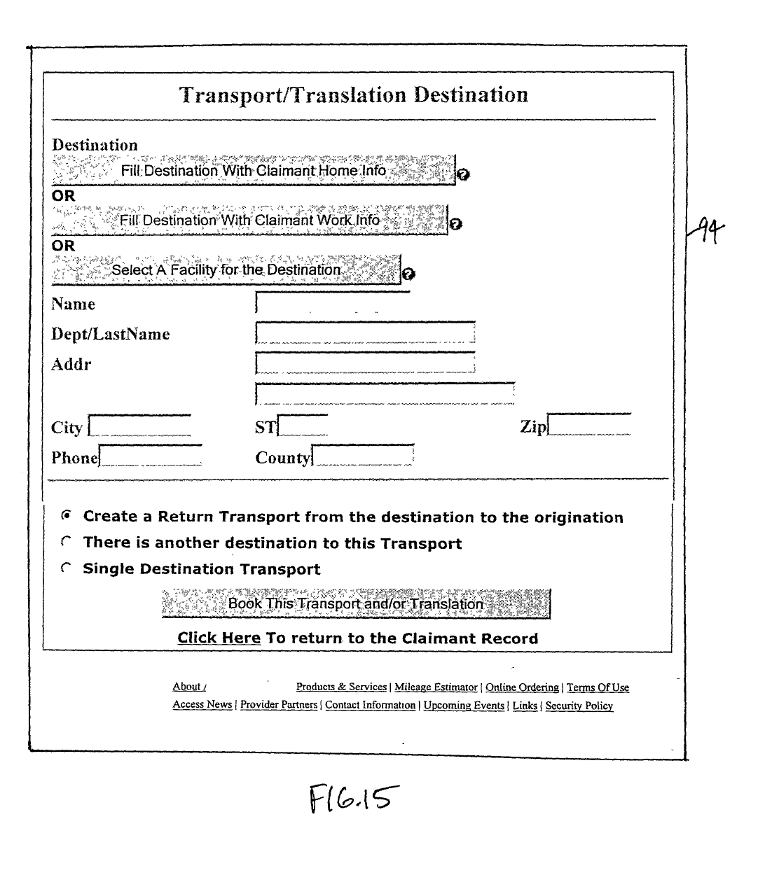

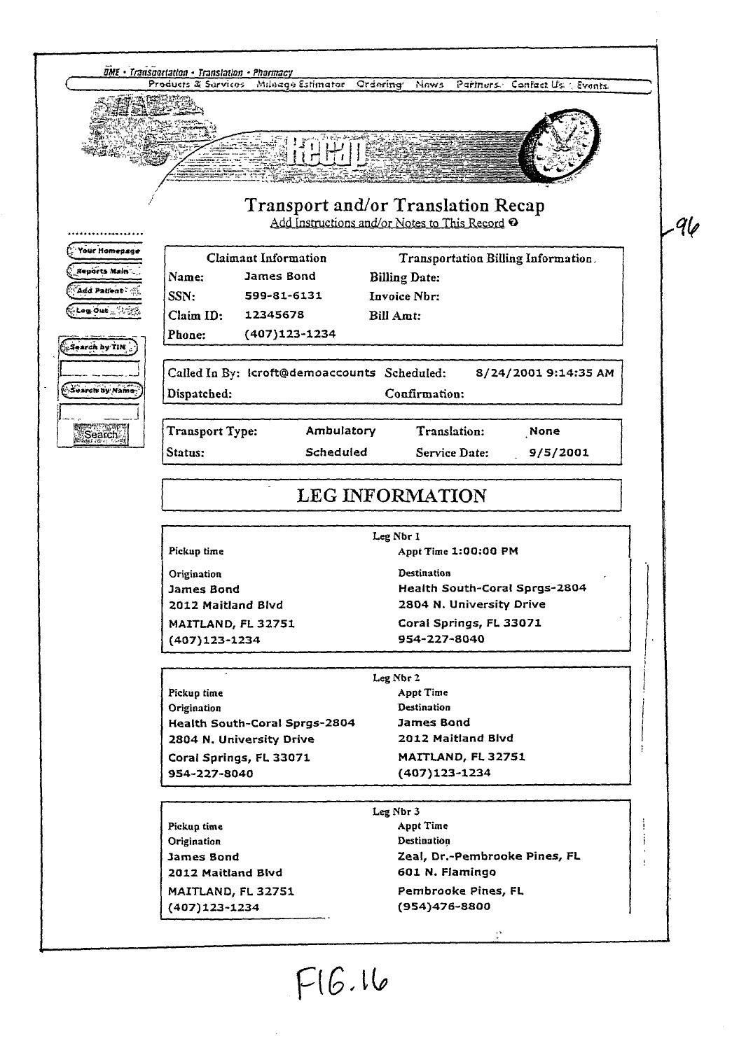

The server may also include a payor secure online ordering unit 52 for the entry and review of claimant data via the payor computer 42. In this case, an authorized insurer, for example, may access the server 32 via the Internet 36 to register new claimants and/or order services for a particular claimant or claimants. Again, such access by the payor or insurer would typically be provided via a web browser on the payor computer 42 and may include customized web pages for a particular payor. For example, an interface 88 (FIG. 12) may include data fields for claimant demographics etc. Also, such web pages may include screens 90 with data fields for selecting the payor or insurer, assigning the adjuster and case manager, and for entering information regarding the claimant's injury, as illustrated in FIG. 13. Service origination, destination and special instructions may be entered via screens 92 and 94, for example, as shown in FIGS. 14 and 15. Of course, a recap and confirmation page 96 (FIG. 16) may also be generated by the server 32.

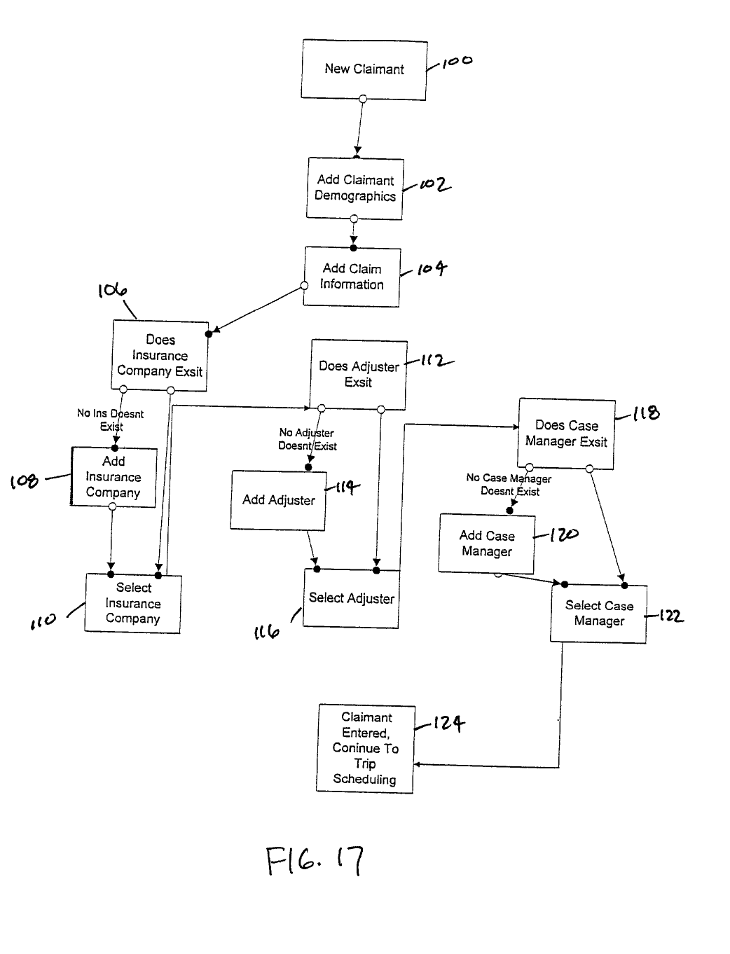

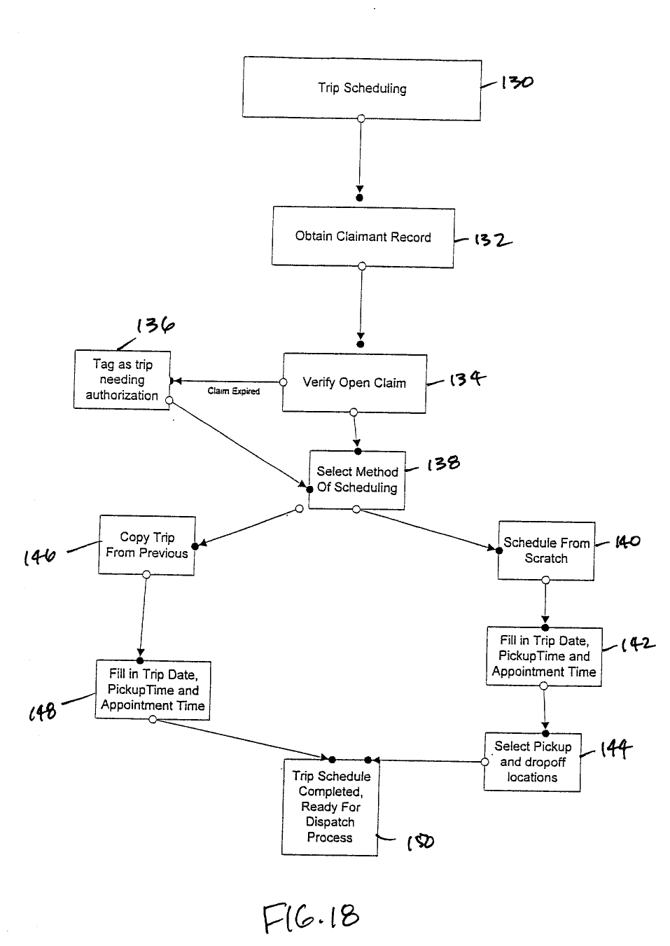

Referring to FIGS. 17 and 18, examples of the claimant registration and service scheduling process will now be described with reference to the pages illustrated in FIGS. 12-18. To add a New Claimant 100, the authorized user, such as the scheduler or payor, would Click on the Add Patient link on the page 88 (FIG. 12), complete the required fields (Blocks 102 and 104) such as Claimant's SSN, Claimant's First Name, Claimant's Last Name etc. Also, the user would complete other details to give more complete claimant information. The interface provided by the secure online ordering unit 52 is easy to use with features such as: “Press to find info based on Zip” tool which auto-fills City, State, County, Phone Area Code and Time Zone fields; “Select Payer Source”, “Assign and Adjuster”, and “Assign a Case Manager” buttons (FIG. 13) which allow the user to select the required Company/Person from a pre-existing, approved list (Blocks 106-122). If no Claim Number is entered, the unit 52 will input the Claimant's SSN. Clicking on the “Save Changes” button will then create a claimant record (Block 124).

To schedule a New Transport/Translation (Blocks 130-150), the user would click on the Schedule a New Transport and/or Translation for this Claimant link from within the Claimant's record 88 (FIG. 12). If required, the correct Transport Type is chosen from the provided list, and the correct Translation Language is chosen from the provided list. The date of service, appointment time, pick up time are entered as well as Claimant's Origination and Destination points. Again, for ease of use, there are buttons which will auto-fill Claimant Home/Work details and will help you find the required facility (92: FIG. 14). To complete the process, the user clicks on the “Book this Transport and/or Translation” button on screen 94 (FIG. 15).

The server may also include a billing unit 56 for verifying service performed by the service vendor and for generating bills for the payor. Preferably, when the service involves transportation of the claimant, DME or drugs, the billing unit 56 verifies mileage of transportation provided by the service vendor. Also, the billing unit 56 automates a vendor bill auditing process. For example, when a vendor bill is received and matched with the corresponding claimant record, the billing unit 56 verifies that the bill is accurate. This verification preferably involves comparing the vendor bill with an internally generated estimate which may account for pre-negotiated rates for different vendors and payors and/or for different geographical areas, as well as for desired profit margins, for example. If a discrepancy is determined based upon a difference between the vendor bill amount and the billing unit 56 estimated amount, or a range based upon the estimated amount, a variation report may be generated by the billing unit 56. The variation report may include a request to a workstation 34 computer 38 to contact the appropriate vendor to determine the reason for the discrepancy. The variation report and/or vendor bill may also be sent to a renegotiate queue.

The server 32 may further include a dispatch unit 50 for prioritizing the claimant data for scheduled services, queuing the claimant data to the scheduler computer 38 based upon priority, and generating a service vendor list to the scheduler computer based upon a geographical area related to the claimant. For example, the geographical area may be the city, county or state where the claimant lives or needs to be transported. In other words, the dispatch unit 50 may prioritize claimant data by the chronology of services needed or the urgency of services needed. Then, the claimant data, such as name, address, phone number, destination etc., are queued to and displayed on the scheduler computer 38 for scheduling and dispatch of the services. The service vendor list may also include any previous service vendors for the claimant, and/or a quality rating of the listed service vendors.

The server 32 may also include a quality assurance (QA) unit 54 for generating requests to the scheduler computer 38 before and after the scheduled service for contacting the claimant, and for generating requests to the scheduler computer before the scheduled service for contacting the service vendor. In other words, the QA unit 54 processes the claimant data for services that are scheduled, and generates a request to the scheduler to contact the claimant, via the telephone interface 40, for example, with a reminder that they are going to be picked up at a given time for transportation to their healthcare appointment. Next or simultaneously, the QA unit 54 generates a request to the scheduler to contact the service vendor, via the telephone interface 40, for example, with a reminder that they are scheduled to pick up a claimant at a given time for transportation to the healthcare appointment. Lastly, the QA unit 54 generates a request to the scheduler after the scheduled service to contact the claimant for verification that they were in fact picked up and transported to their healthcare appointment.

Additionally, when the services include transportation and/or language translation, the QA unit 54 may generate requests to the scheduler computer 38 during the scheduled service to verify the service is currently being provided. For example, the request generated by the QA unit 54 to the scheduler computer 38 may include the telephone number for the healthcare office and the scheduler may contact the office while the claimant is supposed to be there. Also, the request generated by the QA unit 54 to the scheduler computer 38 may include the mobile telephone number for the service vendor and the scheduler may contact the vendor while the claimant is supposed to be in route to their appointment.

Furthermore, the report generation unit 48 may also generate completed-service, late-service, canceled-service and missed-service reports on the server 32 for the payor to access via the Internet 36. These reports may also be downloadable by the payor into a spreadsheet document on the payor computer 42. Thus, real-time verification and analysis of the claimant's services are provided to the insurer to more efficiently manage the claim and reduce overall costs and fraud.

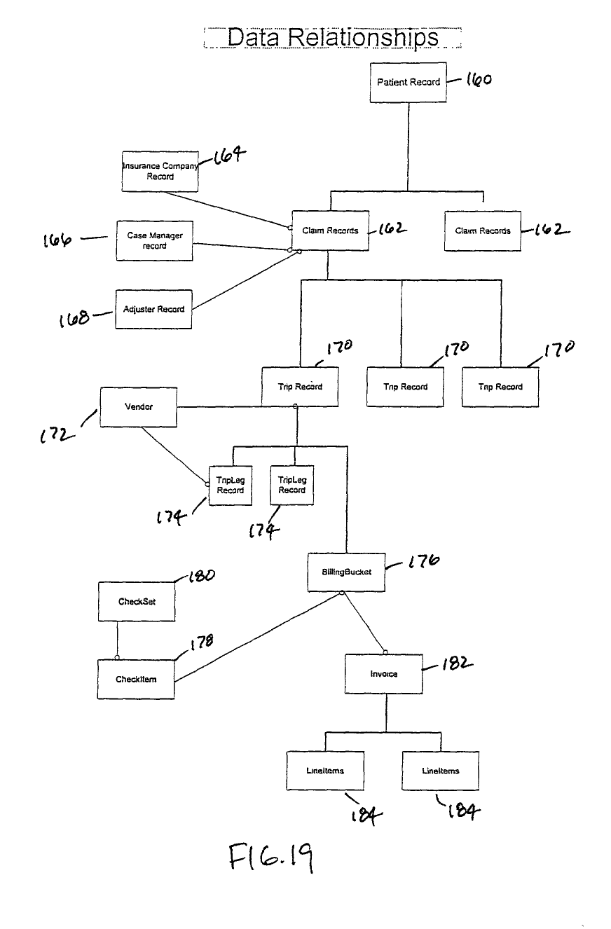

As mentioned above, the server 32 may include various databases such as a claimant data database 60 and/or a report database 62. The claimant data stored on such a database 60 may be formatted into records, such as claimant or patient records 160, for example, which will now be described with reference to the flowchart of FIG. 19. The patient record 160 may include claim records 162 which in turn may include records 164-168 for the insurer, case manager and adjuster. The claim records 162 would also include trip records 170 including vendor and trip information 172 and 174. A billing bucket 176 may also be generated and include various checks, invoices and line items 178-184.

Method aspects of the invention include a method for providing services to a claimant by a service vendor, as scheduled by a scheduler, and paid for by a payor, including processing and storing claimant data on a server 32 connected to the Internet 36, and scheduling services for a claimant via at least one scheduler workstation 34. Again, the workstation 34 includes a scheduler computer 38 connected to the server 32 for entry of claimant data by the scheduler and display of claimant data to the scheduler, and a telephone interface 40 connected to the PSTN for communication between the scheduler and at least one of the payor, claimant and service vendor. The method further includes providing access by the payor to claimant data on the server 32 via the Internet 36 and at least one payor computer 42.

The method may further include generating reports on the server 32 based upon claimant data for the payor to access and review; prioritizing the claimant data for scheduled services, queuing the claimant data to the scheduler computer 38 based upon priority; and generating a service vendor list to the scheduler computer 38 based upon at least one of a geographical area related to the claimant and any previous service vendors for the claimant.

Also, the method may include: generating requests to the scheduler computer 38 before and after the scheduled service for contacting the claimant; generating requests to the scheduler computer before the scheduled service for contacting the service vendor; generating requests to the scheduler computer during the scheduled service to verify the service is being provided.

Some of the features of the system and method of the present invention include: ease of scheduling trips, e.g. book one month of 3-times a week transports from within one process; easily copy a previous transport as a new transport, only needing to fill in date and appointment time; auto fill address with one click for claimant home and work addresses; easily choose from extensive database of Medical Facilities (prevents the need for typing in locations); easily add legs to trips with one click, origination address is auto filled with the destination address of last leg of trip (ease of use, prevents typing); auto fill state, county, time zone, and area code based off the zip code entered; and auto fill payer source information based upon the user that is logged in.

Moreover, other features include: ease of selecting adjuster and case manager information via secondary window selections that are pre-filled with adjuster and case manager information based upon the payer source on the claim; ease of adding notes to claimant records for tracking purposes and to convey messages with schedulers for special needs claimants; week at a glance window allows user to easily verify all upcoming transportation/translations scheduled; today's transports/translations allows users to verify all their services scheduled for the day; Recent Claimants allows users to easily find the claimants that they most recently worked within the system; users can easily verify that trips were completed, cancelled and missed; access to live real time data; customizable home page that each user can control; access to real time billing data; access to reports which detail money spent into logical groupings such as by employer, icd9, county, claimant etc.

Also, the system and methods implement and maintain a secure, trusted environment for data storage to comply with The Health Insurance Portability and Accountability Act of 1996 (HIPAA).

The disclosures of related applications entitled “SYSTEM AND ASSOCIATED METHODS FOR PROVIDING CLAIMANT SERVICES WITH PRIORITIZED DISPATCH” (atty. Docket No. 65508) and “SYSTEM AND ASSOCIATED METHODS FOR PROVIDING CLAIMANT SERVICES AND ACCESS TO CLAIMANT RECORDS AND REPORTS VIA A COMPUTER NETWORK” (atty. Docket No. 65501) to the same inventive entity and concurrently filed herewith are incorporated by reference herein in their entirety.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A system, operable over the public switched telephone network (PSTN) and Internet, for use in providing services to a claimant by a service vendor, as scheduled by a scheduler, and paid for by a payor, the system comprising:
a server for processing and storing claimant data and connected to the Internet; and
at least one scheduler workstation for scheduling services for a claimant and comprising
a scheduler computer connected to the server for entry of claimant data by the scheduler and display of claimant data to the scheduler, and
a telephone interface connected to the PSTN for communication between the scheduler and at least one of the payor, claimant and service vendor;
the server comprising a quality assurance unit for generating requests to the scheduler computer before and after the scheduled service for contacting the claimant, and for generating requests to the scheduler computer before the scheduled service for contacting the service vendor.

2. A system according to claim 1 wherein the services comprises at least one of transportation and language translation; and wherein the quality assurance unit generates requests to the scheduler computer during the scheduled service to verify the service is being provided.

3. A system according to claim 1 wherein the services comprise at least one of transportation, translation, delivery of durable medical equipment (DME), and delivery of pharmaceuticals.

4. A system according to claim 1 wherein the server comprises a report generation unit for generating at least one of completed-service, late-service, canceled-service and missed-service reports on the server for the payor to access via the Internet.

5. A system according to claim 4 wherein the reports are downloadable by the payor into a spreadsheet document on the payor computer.

6. A system according to claim 4 wherein the report generation unit also generates at least one of a transport-type report, claimant transport report, claimant employer transport report, transportation savings report, list of claimants report, transport by county report, and ICD-9 transport report.

7. A system according to claim 1 wherein the server comprises a payor secure online ordering unit for permitting the entry and review of claimant data via the Internet.

8. A system according to claim 1 wherein the server comprises a billing unit for verifying service performed by the service vendor and for generating bills for the payor.

9. A system according to claim 1 wherein the service comprises transportation and the billing unit verifies mileage of transportation provided by the service vendor.

10. A system according to claim 1 wherein the payor is a workers compensation insurer and the claimant is a workers compensation claimant.

11. A system, operable over the public switched telephone network (PSTN) and Internet, for use in providing services to a claimant by a service vendor, as scheduled by a scheduler, and paid for by a payor, the system comprising:
a server for processing and storing claimant data and connected to the Internet; and
at least one scheduler workstation for scheduling services for a claimant and comprising
a scheduler computer connected to the server for entry of claimant data by the scheduler and display of claimant data to the scheduler, and
a telephone interface connected to the PSTN for communication between the scheduler and at least one of the payor, claimant and service vendor;
the server comprising a report generation unit for generating at least one of completed-service, late-service, canceled-service and missed-service reports on the server for the payor to access via the Internet.

12. A system according to claim 11 wherein the reports are downloadable by the payor into a spreadsheet document via the Internet.

13. A system according to claim 12 wherein the report generation unit also generates at least one of a transport-type report, claimant transport report, claimant employer transport report, transportation savings report, list of claimants report, transport by county report, and ICD-9 transport report.

14. A system according to claim 11 wherein the server further comprises a quality assurance unit for generating requests to the scheduler computer for contacting the claimant and the service vendor.

15. A system according to claim 11 wherein the services comprise at least one of transportation, translation, delivery of durable medical equipment (DME), and delivery of pharmaceuticals.

16. A system according to claim 11 wherein the server comprises a payor secure online ordering unit for permitting the entry and review of claimant data by the payor via the Internet.

17. A system according to claim 11 wherein the server comprises a billing unit for verifying service performed by the service vendor and for generating bills for the payor.

18. A system according to claim 11 wherein the service comprises transportation and the billing unit verifies mileage of transportation provided by the service vendor.

19. A system according to claim 11 wherein the payor is a workers compensation insurer and the claimant is a workers compensation claimant.

20. A method, operable over the public switched telephone network (PSTN) and Internet, for use in providing services to a claimant by a service vendor, as scheduled by a scheduler, and paid for by a payor, the method comprising:
processing and storing claimant data on a server connected to the Internet;
scheduling services for a claimant via at least one scheduler workstation which comprises
a scheduler computer connected to the server for entry of claimant data by the scheduler and display of claimant data to the scheduler, and
a telephone interface connected to the PSTN for communication between the scheduler and at least one of the payor, claimant and service vendor;
generating requests to the scheduler computer before and after the scheduled service for contacting the claimant; and
generating requests to the scheduler computer before the scheduled service for contacting the service vendor.

21. A method according to claim 20 wherein the services comprises at least one of transportation and language translation; and further comprising generating requests to the scheduler computer during the scheduled service to verify the service is being provided.

22. A method according to claim 20 wherein the services comprise at least one of transportation, translation, delivery of durable medical equipment (DME), and delivery of pharmaceuticals.

23. A method according to claim 20 further comprising:
generating at least one of completed-service, late-service, canceled-service and missed-service reports on the server; and
permitting access to the reports on the server by the payor via the Internet.

24. A method according to claim 23 wherein the reports are downloadable by the payor into a spreadsheet document.

25. A method according to claim 23 further comprising generating at least one of a transporttype report, claimant transport report, claimant employer transport report, transportation savings report, list of claimants report, transport by county report, and ICD-9 transport report.

26. A method according to claim 20 further comprising permitting the entry and review of claimant data by the payor via the Internet.

27. A method according to claim 20 further comprising:
verifying service performed by the service vendor; and
generating bills for the payor.

28. A method according to claim 20 wherein the service comprises transportation; and further comprising verifying mileage of transportation provided by the service vendor.

29. A method according to claim 20 wherein the payor is a workers compensation insurer and the claimant is a workers compensation claimant.
